(19) United States
(12) Patent Application Publication
(10) Pub. No.: US 2012/0326887 A1
(43) Pub. Date: Dec. 27, 2012

(54) DIGITAL SIGNAGE SYSTEM

(75) Inventor: Toshiyuki Inoko, Tokyo (JP)

(73) Assignee: TEAM LAB INC., Tokyo (JP)

(21) Appl. No.: 13/579,283

(22) PCT Filed: Jul. 30, 2010
(86) PCT No.: PCT/JP2010/004835

§ 371 Date: Sep. 6, 2012

(30) Foreign Application Priority Data
Feb. 19, 2010 (JP) 2010-034278

(51) Int. Cl. H04Q 9/00

(52) U.S. Cl. 340/870.07

(57) ABSTRACT

[Problem] The present invention is intended to provide a digital signage system which can measure depth of interest of customers and can perform sales promotion to the customers.

[Method of settlement] The digital signage system of the present invention can measure depth of interest of customers, by which a database 22 memorizes an amount of time during which the customers have taken out a clothes hanger from a hanger tack and a time update section 24 updates this and accumulates them. Willingness of the customers to buy can be increased by analyzing clothing information which the customers have picked up and by displaying an image with respect to the clothing article on a monitor in the vicinity of the customers.

### TECHNICAL FIELD

The present invention relates to a digital signage system that can appropriately grasp the degree of customers' interest in clothes and can increase willingness of the customers to buy the clothes.

### BACKGROUND ART

A merchandise management system of a clothing article is disclosed in Japanese Patent Laid-Open No. 2009-234,712. This system is for performing “careful information gathering with respect to customer trends in the case that some customers are interested in the clothing article a little bit and have the clothing article in hand briefly or do others.

### PRIOR ART REFERENCES

### Patent References

[Patent reference 1] Japanese Patent Laid-Open No. 2009-234,712 Official Gazette

### SUMMARY OF INVENTION

### Problems To Be Solved By the Invention

The system of Japanese Patent Laid-Open No. 2009-234,712 can determine whether a customer picked up a clothing article or not. However, this system cannot measure depth of interest of the customer. In addition, this system cannot perform sales promotion to the customer.

Therefore the present invention is intended to provide a digital signage system that can measure the depth of interest of the customer.

The present invention is also intended to provide a digital signage system that can perform sales promotion to customers.

### Means For Solving the Problem

The present invention is fundamentally based on knowledge that depth of interest of customers can be measured by summing the amount of time spent in the customers taking out a clothes hanger from a hanger rack.

In addition, the present invention is fundamentally based on knowledge that customer's willingness to buy can be increased by analyzing information of a clothing article that a customer took in hand and by displaying an image with respect to the clothing article on a monitor in the vicinity of the customer.

The first aspect of the present invention relates to a digital signage system 1 comprising a clothes hanger 12 having a sensor device 11, a computer 21, and a monitor.

The sensor device 11 comprises a sensor section 13, which performs measurement to judge whether the clothes hanger 12 is hung on a hanger rack or not, a judgment section 14, which is for judging whether it is hung on the hanger rack or not by receiving sensing information from the sensor section 13, an ID memory section 15, which memorizes an ID of the sensor device, and a transmitter-receiver section 16 of the clothes hanger, which transmits judgment information of the judgment section as well as the sensor device ID memorized in the ID memory section into the computer.

The computer 21 comprises a database 22, a transmitter-receiver 23 of the computer, a time update section 24, a clothing information arithmetic-logical section 25. In plural sensor devices, the database 22 memorizes an ID of each sensor device, information of clothes hung on the clothes hanger provided with each sensor device, and an amount of time during which the clothes hanger provided with each sensor device are removed out from the hanger rack, by associating them with each other. The transmitter-receiver 23 of the computer receives the judgment information and the ID information that the transmitter-receiver 16 of the clothes hanger has transmitted. The time update section 24 performs process of updating, based on the ID information and the judgment information that the transmitter-receiver 23 of the computer have received, the amount of time, during which the clothes hanger associated with the ID information are removed out from the hanger rack, in the database. The clothing information arithmetic-logical section 25 is for reading out information with respect to the clothes hung on the clothes hanger, which is memorized by associating with the ID information, from the database 22, and for transmitting it from the transmitter-receiver 23 of the computer.

The monitor receives the information with respect to the clothes transmitted from the transmitter-receiver 23 of the computer and performs display of the clothes.

The first preferred aspect of the present invention further comprises a photograph device photographing the area around the clothes hanger 12. In addition, the computer 21 further comprises an image processing section that receives information with respect to face of a customer, who picked up a clothes hanger, from the photograph device, and reads out information, which is memorized in conjunction with the ID information from the database 22, with respect to the clothes hung on the clothes hanger, and then performs processing to generate an image of the customer wearing the clothes by image synthesis. Then, the computer 21 transmits the processed image from the transmitter-receiver 23 of the computer to the monitor.

The first preferred aspect of the present invention is the one that power supply of the sensor device 11 becomes ON state in the case that the clothes hanger 12 is removed out from the hanger rack.

### Effects of the Invention

The present invention can measure depth of interest of customers by summing the amount of time spent in the customers taking out a clothes hanger from hanger rack.

In addition, the present invention can increase customer' willingness to buy by analyzing clothing information that a customer picked up and by displaying an image of the clothing article on a monitor in the vicinity of the customer.

### BRIEF DESCRIPTION OF THE DRAWINGS

FIG. 1 is a schematic drawing of a system of the present invention.

FIG. 2 is a schematic drawing to explain an embodiment of a clothes hanger of the present invention.

### DETAILED DESCRIPTION OF THE INVENTION

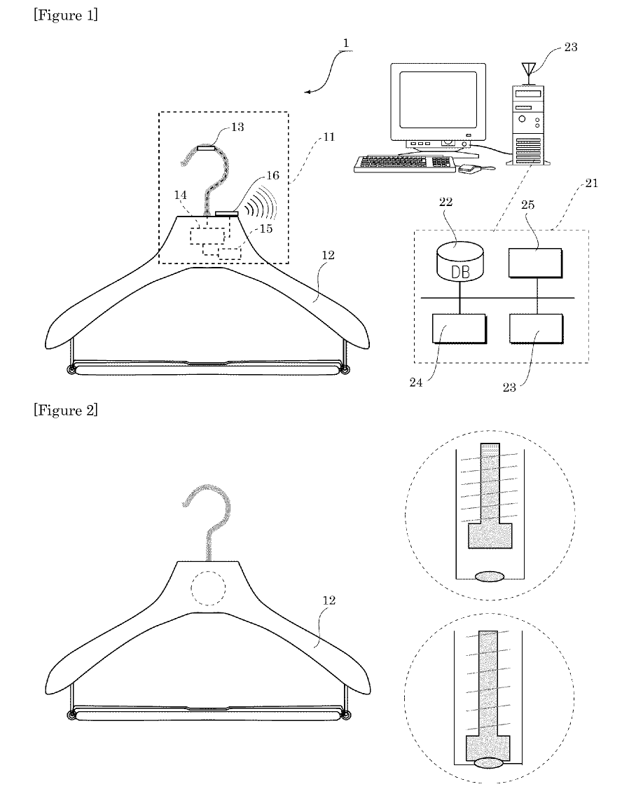

FIG. 1 is a schematic drawing of a system of the present invention. As shown in FIG. 1, the first aspect of the present invention relates to a digital signage system 1 comprising a clothes hanger 12 having a sensor device 11, a computer 21, and a monitor (not shown).

As shown in FIG. 1, the sensor device 11 comprises a sensor section 13, a judgment section 14, an ID memory section 15, and a transmitter-receiver 16. The sensor section 13 performs measurement to judge whether a clothes hanger 12 is hung on a hanger rack or not. Examples of the sensor section 13 are a pressure sensor, a ZigBee, a RFID chip.

FIG. 2 is a schematic drawing to explain an embodiment of a clothes hanger of the present invention. As shown in FIG. 2, an example of the clothes hanger is the one that the clothes hanger comprises a core of the clothes hanger, a spring section attached to the core, and a power supply system that power supply is turned “ON” by a spring in a state that the clothes hanger is removed out from a hanger rack. In addition, mechanism of ON/OFF switch of the power supply of the present invention is not limited to the one having the spring. For example, the ON/OFF switch of the power supply may be controlled by using magnets and/or a pressure sensor. An embodiment is the one that the power supply is turned “ON” in the case that two magnets stick to each other, and that power supply is turned “OFF” by the two magnets being separated from each other by weight of the clothes hanger. For example, the pressure sensor does not hit the core in the case that the clothes hanger is hung on the hanger rack and the pressure sensor hits the core in the case that the clothes hanger is removed out from the hanger rack, and then the pressure sensor should issue an instruction that turns the power supply “ON” from the pressure sensor to the power supply in the latter case.

The judgment section 14 is a device to receive sensing information from the sensor section 13 and to judge whether it is hung on the hanger rack or not.

The ID memory section 15 is a device to memorize an ID of the sensor device.

The transmitter-receiver section 16 of the clothes hanger is a device to transmit judgment information of the judgment section as well as the ID of the sensor device, which is memorized in the ID memory section, to the computer.

A state that the clothes hanger 12 is hung on the hanger rack changes into a state that it is removed out from the hanger rack. Then, in the example of FIG. 1, the sensor section 13, which is a pressure sensor, senses a pressure change and transmits pressure information to the judgment section 14. The judgment section 14 reads out a threshold value from the memory section, compares the transmitted pressure with the predetermined threshold, and then judges whether it is hung on the hanger rack or not. If the judgment section 14 judges that the clothes hanger is in a state that it has been removed out from the hanger rack, an ID of the sensor device (i.e., an ID of the clothing article that is hung on the hanger rack) is read out from the ID memory section 15, and judgment information of the judgment section (information that the clothes hanger is in a state that it has been removed out from the hanger rack) as well as the ID of the sensor device is transmitted to the computer.

In the example of FIG. 2, in a state that the clothes hanger is hung on the hanger rack, as shown in the upper right diagram of FIG. 2, a core of the clothes hanger is pulled upward and the core of the clothes hanger is in a state that it has been disconnected from a plate. On the other hand, in a state that the clothes hanger has been removed out from the hanger rack, as shown in the lower right diagram of FIG. 2, the core of the clothes hanger is pushed towards the plate side by a spring. As a result, the core of the clothes hanger touches the plate. Then, a power supply system is turned “ON”. In this way, a system comprising the core of the clothes hanger, the plate, and the spring functions as the sensor section 13. In addition, information that the power supply system has been turned “ON” can be used as judgment information of the judgment section 14. In other words, if the power supply system has been turned “ON”, an ID of the sensor device (i.e., an ID of the clothing article that is hung on the hanger rack) is read out from the ID memory section 15 and it as well as the ID of the sensor device are transmitted to the computer.

The computer 21 comprises a database 22, a transmitter-receiver section 23 of the computer, a time update section 24, and a clothing information arithmetic-logical section 25.

With respect to plural sensor devices, the database 22 memorizes an ID of each sensor device, information with respect to a clothe that is hung on the clothes hanger provided with each sensor device, and the amount of time during which the clothes hanger provided with each sensor device is removed out from the hanger rack, by associating them with each other.

The ID of the sensor device may be the same as an ID of the clothing article hung on the clothes hanger. Examples of information with respect to a clothe are one or more than one of a manufacturing company of the clothe, a brand of the clothe, a, producer of the clothe, a producer of suit or dress material, a price of the clothe, a manufacturer, a pictorial image, and an animated image. An example of the pictorial image is a pictorial image indicating a state that a model wears the clothing article identified by the ID. In addition, it may be a pictorial image indicating a state that the clothing article is really worn, to use for image synthesis as mentioned later. The animated image may be a PR animated image of the clothe.

The transmitter-receiver section 23 of the computer is a device to receive judgment information and ID information which the transmitter-receiver section 16 of the clothes hanger has transmitted.

The time update section 24 is a device to perform processing to update the amount of time during which the clothes hanger with respect to ID information, which is memorized in the database on the basis of judgment information and ID information which the transmitter-receiver section 23 of the computer has received, is removed out from the hanger rack. In other words, the time update section 24 measures an amount of time during which a clothing article identified by a certain ID is removed out from the hanger rack. Then, the amount of time memorized in the database so far is read out, and the read-out time and the measured time are summed up. In addition, the summed up time is inputted into the database and the amount of time during which the clothes hanger with respect to the ID information is removed out from the hanger rack is updated.

Because the system of the present invention comprises the time update section 24, total amount of time during which a certain clothe is taken by the hands of customers can be appropriately grasped. In other words, not only whether it has been really sold or not but also how much interest the clothe has gained can be appropriately grasped.

The clothing information arithmetic-logical section 25, for example, read out information, which is memorized in connection with the ID information from the database 22, with respect to the clothes hung on the clothes hanger, to transmit information of a pictorial image and/or an animated image to be displayed on the monitor. In addition, the clothing information arithmetic-logical section 25 makes transmission of the read-out information from the transmitter-receiver section 23 of the computer.

The first preferred aspect of the present invention further comprises a photograph device that photographs the area around the clothes hanger 12. In addition, the photograph device extracts face information of a customer. The method to extract the face information is well known. In other words, because a customer and scenery are different from each other in pictorial image information, only the image of the customer can be extracted by grasping change of the pictorial image. In addition, the computer 21 receives information with respect to the face of the customer, who has picked up a clothes hanger, from the photograph device. Then the computer 21 reads out information, which is memorized in connection with the ID information from the database 22, with respect to the clothe hung on the clothes hanger. This information with respect to the clothe is a pictorial image indicating a state that the clothing article has been really worn to use for image synthesis. Then, the pictorial image that the customer wears the clothe is synthesized by combining the read out pictorial image indicating the state of the customer wearing the clothe with the face of the customer. Then the computer 21 transmits the processed image from the transmitter-receiver section 23 of the computer to the monitor.

The monitor receives the information, which has been transmitted from the transmitter-receiver 23 of the computer, with respect to the clothe, and performs display with respect to the clothe. The monitor comprises a receiving section such as an antenna not shown here. In addition, the receiving section receives predetermined information and synthesize a pictorial image and shows it on the monitor. In this way, the information with respect to the clothe is displayed on the monitor and can attract interest of the customer.

### INDUSTRIAL APPLICABILITY

The present invention can be preferably used in the field(s) of advertising industry and/or device business with respect to advertisement.

### EXPLANATION OF LETTERS OR NUMERALS

1 Digital signage system

11 Sensor device

12 Clothes hanger

13 Sensor section

14 Judgment section

15 ID memory section

16 Transmitter-receiver section of clothes hanger

21 Computer

22 Database

23 Transmitter-receiver section of computer

24 Time update section

25 Clothing information arithmetic-logical section

1. A digital signage system (1) comprising a clothes hanger (12) having a sensor device (11), a computer (21), and a monitor,
wherein the sensor device (11) comprises:
a sensor section (13) performing measurement to judge whether the clothes hanger (12) is hung on a hanger rack or not;
a judgment section (14) to receive sensing information from the sensor section (13) and to judge whether it is hung on the hanger rack or not;
an ID memory section (15) memorizing an ID of the sensor device, and
a transmitter-receiver section (16) of the clothes hanger which transmits judgment information of the judgment section as well as the ID of the sensor device, which is memorized in the ID memory section, to the computer;
the computer (21) comprises:
a database (22) memorizing, with respect to plural sensor devices, an ID of each sensor device, information with respect to a clothe hung on the hanger rack provided with each sensor device, and an amount of time during which the clothes hanger is removed out from the hanger rack, by associating them with each other;
a transmitter-receiver section (23) of the computer, which receives the judgment information and the ID information that have been transmitted by the transmitter-receiver section (16) of the clothes hanger;
a time update section (24) that performs processing to update an amount of time, during which the clothes hanger with respect to the ID information is removed out from the hanger rack, in the database, on the basis of the judgment information and the ID information, which have been received by the transmitter-receiver section (23) of the computer; and
a clothing information arithmetic-logical section (25) to read out information, which is memorized in conjunction with the ID information, with respect to the clothe hung on the hanger rack, from the database (22), and to make transmission from the transmitter-receiver section (23) of the computer,
the monitor
receives the information, which has been transmitted by the transmitter-receiver (23) of the computer, with respect to the clothe, and perform display with respect to the clothe.

2. The digital signage system (1) in accordance with claim 1,
wherein it further comprises a photograph device that photographs the area around the clothes hanger (12),
the computer (21) further comprises a image processing section, which receives information with respect to face of the customer who has picked up the clothes hanger from the photograph device, read out information, which is memorized in conjunction with the ID information, with respect to the clothe hung on the clothes hanger, from the database (22), and performs processing to synthesize a pictorial image of the customer wearing the clothe,
the computer (21) transmits the processed-image from the transmitter-receiver section (23) of the computer to the monitor.

3. The digital signage system (1) in accordance with claim 1,
wherein the sensor device (11) makes power supply be in ON state in the event that the clothes hanger (12) has been removed out from the hanger rack.
